(19) United States
(12) Patent Application Publication
(10) Pub. No.: US 2003/0039025 A1
(43) Pub. Date: Feb. 27, 2003

(54) Semiconductor laser module

(75) Inventors: Akira Mugino, Newton Upper Fall, MA (US); Takeshi Aikiyo, Chiyoda-ku (JP); Takeo Shimizu, Chiyoda-ku (JP); Naoki Hayamizu, Chiyoda-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO. LTD., CHIYODA-KU (JP)

(21) Appl. No.: 09/938,580

(22) Filed: Aug. 27, 2001

(51) Int. Cl. H01S 3/00

(52) U.S. Cl. 359/334

(57) ABSTRACT

A semiconductor laser module contains a wavelength selective feedback mechanism that has a center wavelength positioned a predetermined wavelength separation away from a peak gain curve of multiple output modes of light produced by a semiconductor laser contained in the module. In particular, the amount of separation between the center wavelength of the wavelength selective feedback mechanism is set such that modes occurring a predetermined wavelength separation on either side of the center wavelength, are on a same side of a gain curve of the semiconductor laser, with regard to a wavelength in which peak gain is observed. With lasers that have ripples in a characteristic gain curve thereof, the bandwidth of the wavelength selective feedback mechanism is set so that the local peaks of the gain curve decrease (or increase) monotonically therethrough. When the ripples are absent in the gain curve, the slope of the gain curve remains monotonic throughout the reflectance bandwidth.

### CROSS REFERENCE TO RELATED PATENT DOCUMENTS

The present document contains subject matter that relates to that disclosed co-pending, commonly assigned U.S. patent application Ser. No. 09/527,748, CPA filed Jul. 28, 2000, the entire contents of which being incorporated herein by reference.

### TECHNICAL FIELD

The present invention relates to a semiconductor laser module for emitting laser light, and more specifically, to a semiconductor laser module for exciting an Er³⁺, Al³⁻ doped fiber amplifier (EDFA) and/or for 14XX nm pump laser sources for providing optical light for use in Raman Amplifiers.

### BACKGROUND ART

D-WDM (Dense Wavelength Division Multiplexing) optical system technology has been increasingly developed recently. In this technology, optical signals are attenuated as they travel within the optical fiber. To prevent the signal level of the optical signals from dropping too close to a noise floor, the optical signals are amplified, thus boosting the level of the signals well above the noise floor. Optical fiber amplifiers, like EDFAs (Erbium Doped Fiber Amplifiers) and Raman amplifiers, are deployed at certain intervals along the optical fiber line to provide the requisite amplification.

These amplifiers employ an optical fiber as part of the optical fiber amplifier, and the optical signals are amplified as the optical signals propagate through the optical fiber portion of the amplifier. The amplification operation relies on light power emitted from a semiconductor laser module to excite the optical fiber as the signals travel through the optical fiber.

In order to provide well controlled amplification, the wavelength and power of the light emitted from the semiconductor laser module should remain steady. The present inventors recognized that the optical output characteristics of the light emitted from the semiconductor laser module should be highly predictable over the dynamic range of the injection current that is applied to laser(s) in the semiconductor laser module. This is because different end-users will have different operational requirements for the semiconductor laser module, but from the manufacturers perspective the same semiconductor laser module will be sold to different end users. Thus, to ensure the semiconductor laser module product is adequate for all end users, the optical output characteristics of the semiconductor laser module product should be highly predictable over the dynamic range of the injection current. With regard to spectral emission control, the light emitted from the semiconductor laser module should be a stable multi-mode oscillation. Optical feedback techniques, such as using a Bragg grating, are well-known for the purpose of spectral emission control. Each of these devices have a wavelength selective characteristic that is set to be centered over the center wavelength of the light emitted from the semiconductor laser(s), thus ensuring that the maximum power is output from the laser(s).

One technique for observing whether the optical output characteristics are predictable over the entire dynamic range is to observe fluctuations, or discontinuities, so-called “kink,” in the I-L (Injection current vs. Light power) characteristic curve for a semiconductor laser. The I-L characteristic curve is often used as a technical index of the stability of the light power from a semiconductor laser, even if used in combination with such an optical feedback component, like a fiber Bragg grating (FBG).

### SUMMARY OF THE INVENTION

Accordingly, an object of this invention is to provide a novel semiconductor laser module, which enjoys high oscillation wavelength stability over a dynamic range of current injected into a semiconductor laser and despite temperature change, and is suited for use as a light source for EDFA excitation or a high-output, low-noise light source for use in a Raman amplifier, for example.

The present inventors have observed that, as opposed to single mode operation, it is desirable in both 980 nm type lasers as well as 14XX (lasers that are configured to operate at wavelengths in the range of 1400 nm to 1499 nm although even broader ranges of 1300 through 1600 are possible as well) to operate in multiple modes of operation. In such multiple modes of operation, the lasers are configured to operate in a multi-mode operation where multiple modes are simultaneously generated by the laser diode (LD) so as to provide a more stable and predictable power out with low relative intensity noise (RIN). However, the present inventors have also recognized that when operating with multiple modes, that some of the Fabry-Perot (FP) modes may have approximately equal amplitudes, albeit at different wavelengths, with respect to a center portion of a reflection band of a FBG. As a consequence, slight gain changes in the LD's output, perhaps due to a temperature shift, can cause the output level of the LD to “hop” due to a dynamic character of selected modes becoming dominate under otherwise stable operating condition. In such a situation, the injection(driving) current versus monitor current output characteristic will exhibit non-linear features, such as a “kink” in the monitor current output with respect to the injection current. This kink is a nonlinear effect that the present inventors have identified would ideally be suppressed so as to provide laser product that offers highly linear, and reliable output characteristics over the dynamic range of the injection current.

Contrary to conventional practice where Fabry-Perot lasers (which produced multiple modes) are configured to operate at a peak gain, the present inventors have identified that there are benefits associated with operating the multimode lasers at less than a maximum gain so as to avoid kinks in the optical output of the laser product over a full dynamic range of the injection current. Thus, the present inventors have determined operating at an offset between the center portion the reflection band of the FBG, and a peak of a gain curve, provides a desirable linear operation throughout a dynamic range of the injection current for the laser. Accordingly, the present inventors have appreciated the unexpected result of providing improved system performance by operating at less than full gain, and offsetting a peak gain in a multi-mode laser with regard to a center of a reflection band of the FBG (a type of wavelength selective feedback mechanism, WSFM). These effects are observed in both 980 lasers as well as 14XX lasers. The amount of offset, as determined by the present inventors, is established such that the predetermined bandwidth of the reflection band of the FBG is positioned on a sloped portion of the gain curve, preferably a monotonically or decreasing gain from one portion of the reflection band of the WSFM through the other end portion of the reflection band of the WSFM. When the gain curve exhibits a predetermined “ripple,” portions of the reflection band of WSFM has local “peaks”, or ripples, but adjacent local peaks, decrease monotonically throughout the reflection band of the WSFM.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a graph showing a mode distribution when a reflectance bandwidth is centered over a gain peak for a 980 nm or 14XX nm laser;

FIG. 2 shows an effect of suppressing otherwise symmetrical modes about a reflectance bandwidth, when a center frequency of the reflectance bandwidth is offset (detuned) with regard to a peak gain;

FIG. 3 shows a reflectance bandwidth having a center wavelength that overlaps a center portion of a gain curve, when the gain characteristic exhibits a predetermined amount of ripple;

FIG. 4 shows a detuned 14XX nm laser characteristic, where an amount of detuning is characterized by a difference grading amount relative to a center of a reflectance bandwidth, where the difference grading amount is positioned on a same side of a gain peak as a center of the reflectance bandwidth;

FIG. 5 is a graph showing how a desired offset is established when a gain curve exhibits ripple;

FIGS. 6A-6H are respective injection current versus monitor current graphs for different amounts of offset;

FIGS. 7A-7H show spectral plots of spectral output of lasers used to produce the monitor currents in corresponding FIGS. 6A-6H; and

FIG. 8 is a block diagram of a Raman amplifier that uses a plurality of laser modules according to the present invention;

FIG. 9A is a spectrum distribution diagram for a resonance mode form of a gain wavelength characteristic of a GaAs/AlGaAs-based semiconductor laser, a pump laser for optical fiber amplifier, showing an outline of a semiconductor laser module according to the present invention;

FIG. 9B is a spectrum distribution diagram showing a net gain from a laser used to produce the graph of FIG. 9A;

FIG. 10 shows output characteristic curves illustrating the range of an operating current Iₒₚ for I_{BOL and I}_{EOL} based on the relation between the optical output (mW) and an injection current (mA), given in consideration of the initial characteristic and aging of the semiconductor laser;

FIG. 11A shows gain-wavelength characteristic curves illustrating optimum relations between a reflection center wavelength λ_{BG} of a Bragg grating, pulling wavelength width λ PULL, de-tuning width λ_{detune}, shorter-wavelength-side limit value λ_{LIMIT} of the pulling wavelength width λ_{PULL}, and gain peak wavelengths λ(Iₒₚ) and λ (Iₜₕ) for the case where an optical output P_{f} and a monitor output current Iₘ of the semiconductor laser are stable;

FIG. 11B shows gain-wavelength characteristic curves illustrating relations between the aforementioned elements for the case where the monitor current Iₘ of the semiconductor laser are considerably unstable;

FIG. 12A is a spectrum distribution diagram showing optical outputs in two oscillation states measured in the case where mode competition and temporal mode hopping are caused;

FIG. 12B shows an output characteristic curve illustrating a voltage version of time-based change of the monitor current Iₘ measured in the case where mode hopping is caused;

FIG. 13A is a spectrum distribution diagram measured when the optical output P_{f} and the monitor current Iₘ of the semiconductor laser are stable;

FIG. 13B shows an output characteristic curve illustrating a voltage version of time-based change of the monitor current Iₘ;

FIG. 14 shows a characteristic curve related to oscillation wavelength for the injection current of the semiconductor laser device in the semiconductor laser module;

FIG. 15 is a schematic view of the semiconductor laser module of the present invention;

FIG. 16 shows a spectrum characteristic curve for a grating portion formed in an optical fiber used in the semiconductor laser module of FIG. 15;

FIG. 17 shows a spectrum characteristic curve for the case where the semiconductor laser is in a Fabry-Perot resonance state in the semiconductor laser module;

FIGS. 18A to 18C show spectrum characteristic curves illustrating optical outputs (dBm) for the injection current (mA) in the semiconductor laser module of the present invention;

FIG. 18D shows an optical output characteristic curve illustrating an optical output (mW) for the injection current (mA);

FIG. 19 shows a current dependence characteristic curve illustrating the dependence of a variation Iₘ of the monitor current Iₘ on the injection current I_{f} for the case where the semiconductor laser is used singly in the semiconductor laser module of the present invention; and

FIG. 20 shows a current dependence characteristic curve illustrating the dependence of the variation ΔIₘ of the monitor current Iₘ on the injection current I_{f} (mA) of the semiconductor laser in the semiconductor laser module.

### DETAILED DESCRIPTION OF THE INVENTION

A semiconductor laser module according to the present invention, which includes the following features, can restrict fluctuation of optical outputs or fluctuation of monitor current Iₘ, caused by mode hopping or mode competition, within a practically negligible range, in consideration of the relation between a reflection center wavelength λ_{BG} of a Bragg grating and a gain peak λ_{G} for an operating current injected into a semiconductor laser, that is, an injection current (I_{f}).

It should be noted that present invention is suitable for all LD oscillation wavelength ranges, for example, AlGaAs or GaAs lasers that are operated between 970 nm and 990 nm, InGaAs or InGaAsP lasers that are operated between 1350 nm and 1550 nm (namely “14XX” lasers). These 14XX lasers may be used in combination to provide pump light sources for Raman amplifiers, like those discussed in U.S. patent application Ser. No. 09/527,748, the entire contents of which being incorporated herein by reference.

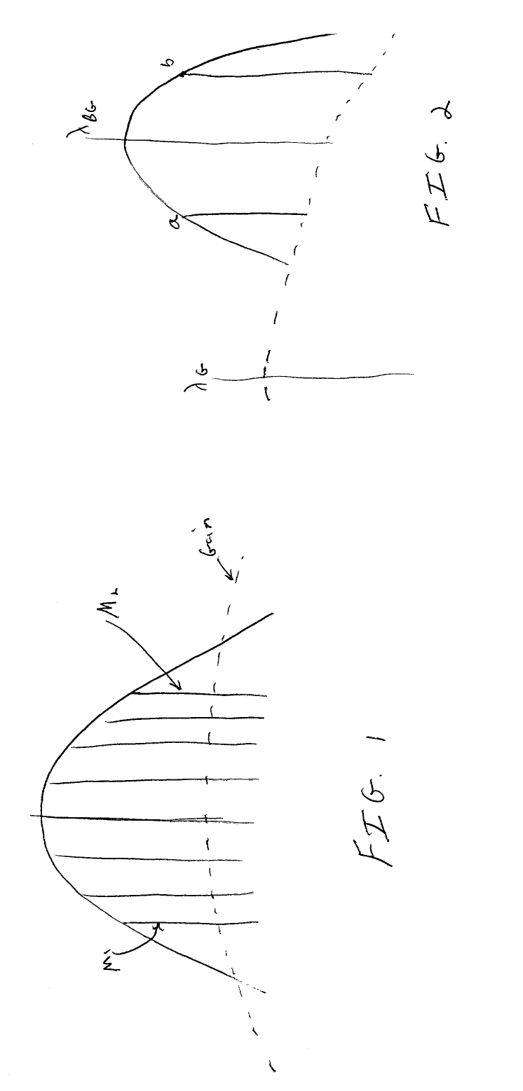

FIG. 1 shows a relationship where a gain peak λ_{G} is generally aligned with a center wavelength of a reflectance bandwidth, λ_{BG}, for a FBG (or more generally a WSFM) at an injection current I_{f} of the LD. In this situation, it is seen that different modes of the multimode laser operation are symmetric about the gain peak λ_{G}. In this case, the possibility arises of having a substantial amount of mode competition noise associated with modes M₁ and M₂, as shown, where the two modes compete with one another regarding which will dominate when producing the output light. By having the different modes competing with one another, the shape of a resulting gain profile (e.g., Raman gain profile) when the laser modules are used as pump lasers will be adversely affected due to the instability of the output spectrum. Accordingly, in addition to the above-described concern with the kink effect, mode competition noise is also an undesirable characteristic that is suppressed by the present invention.

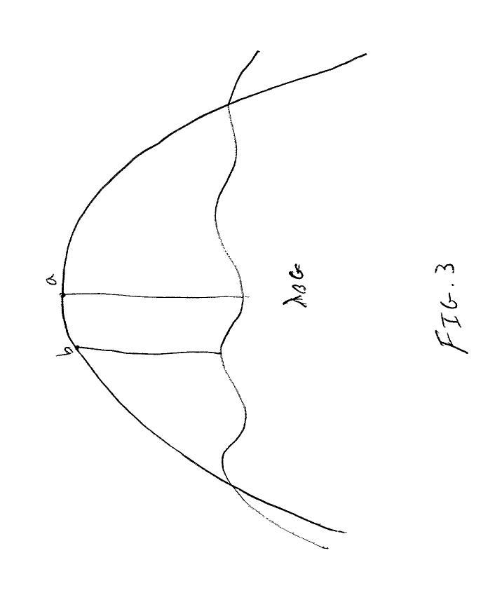

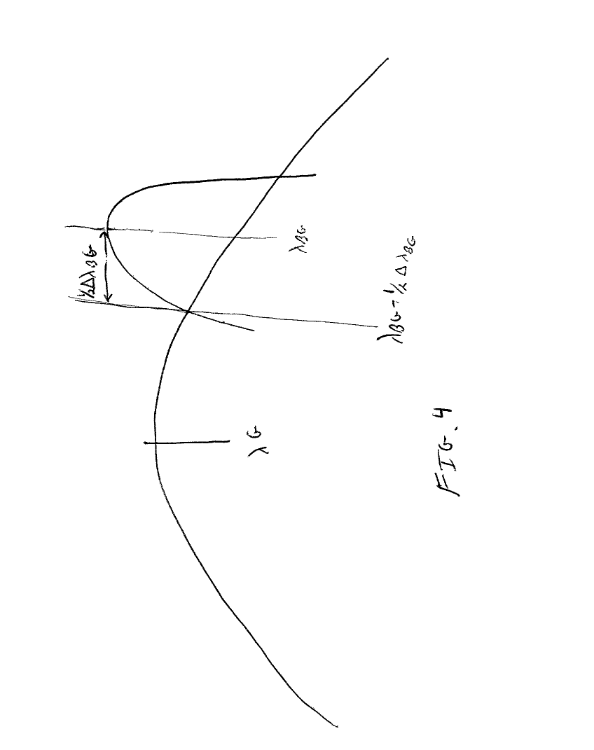

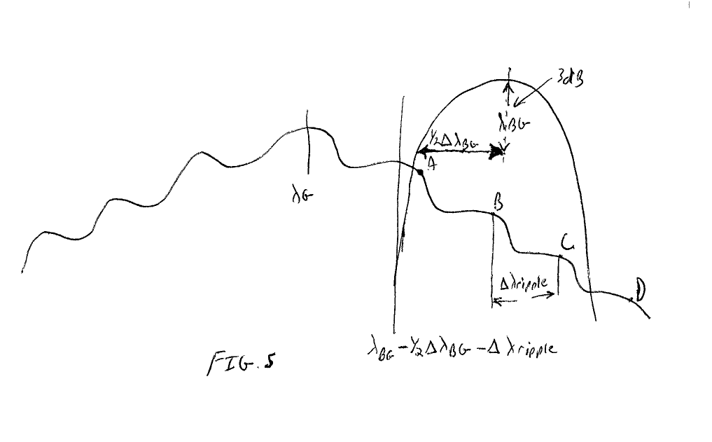

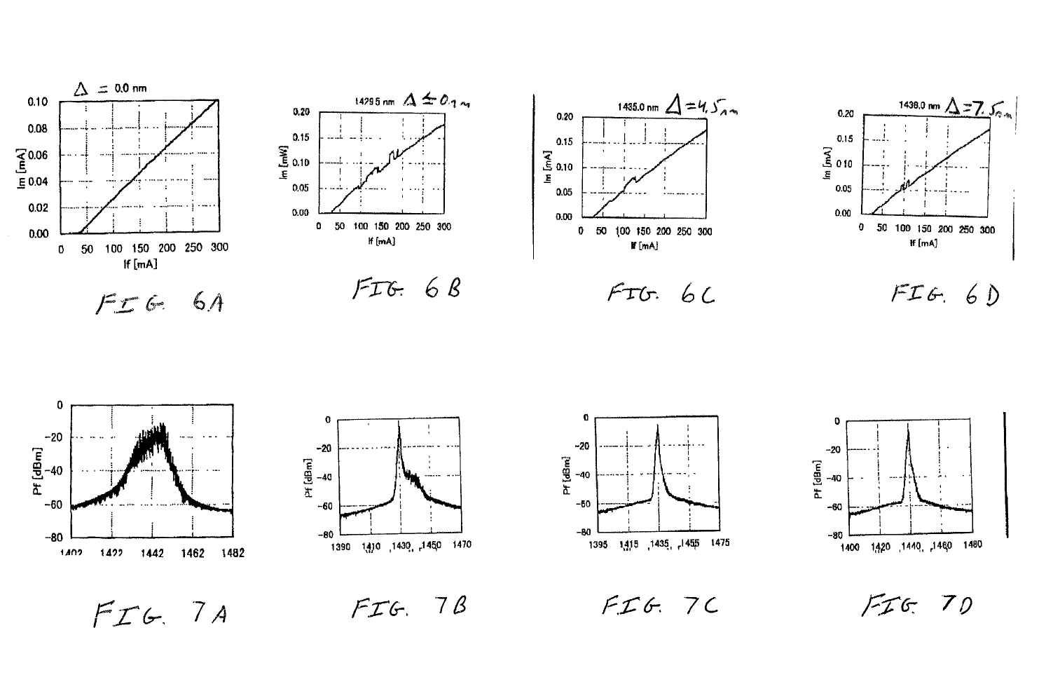

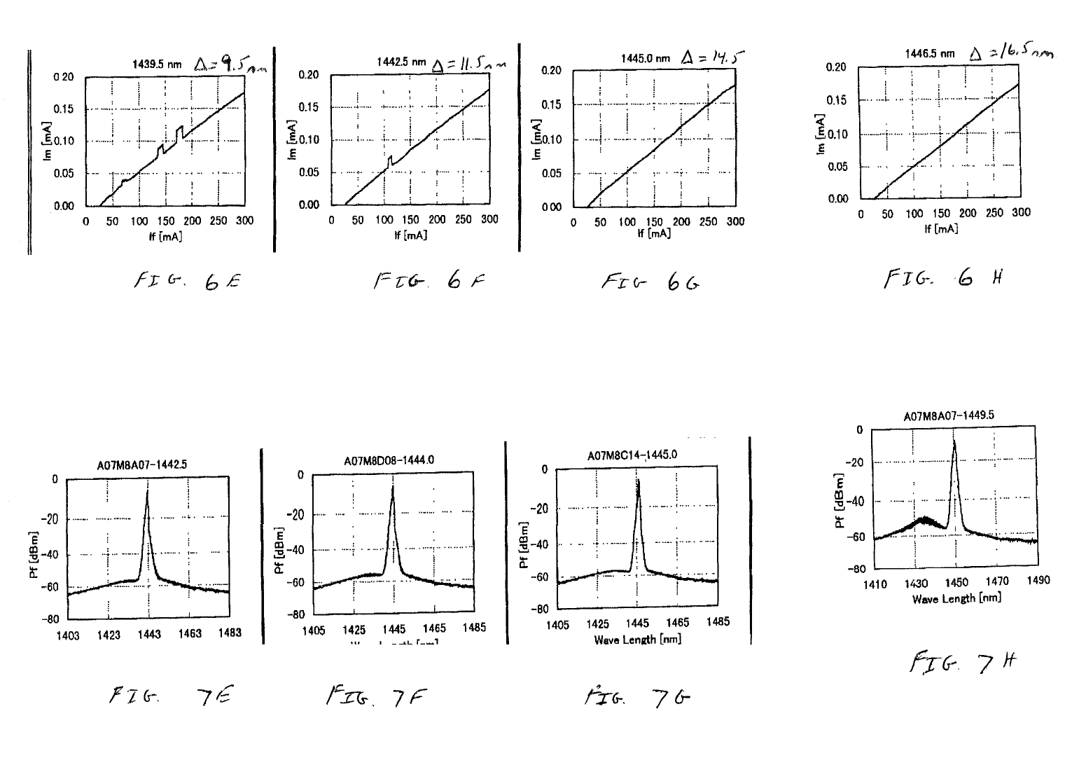

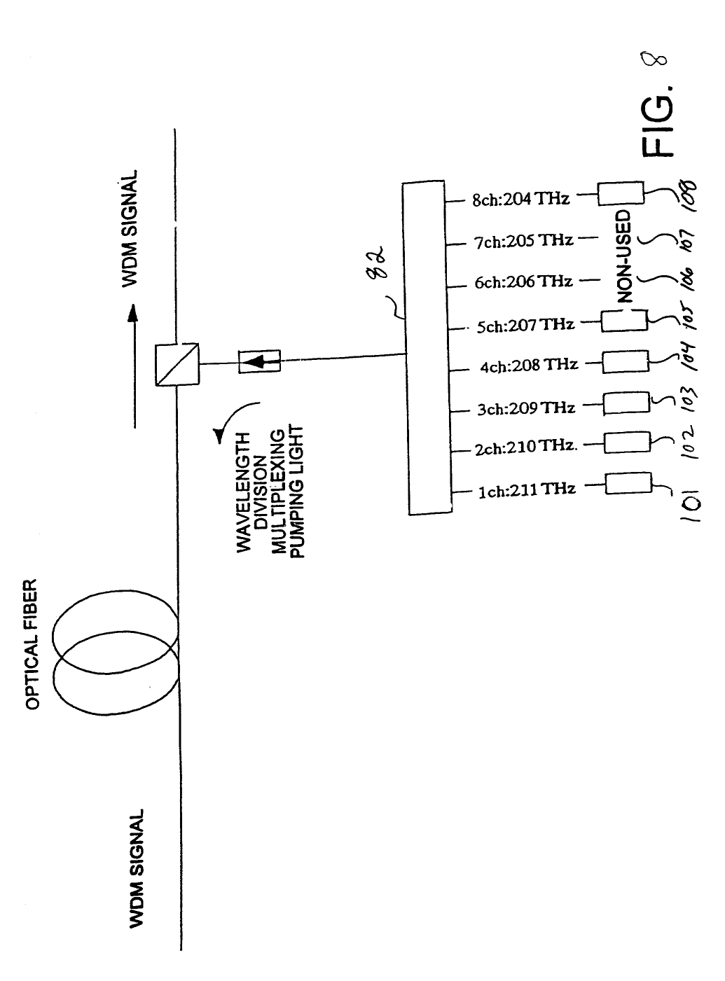

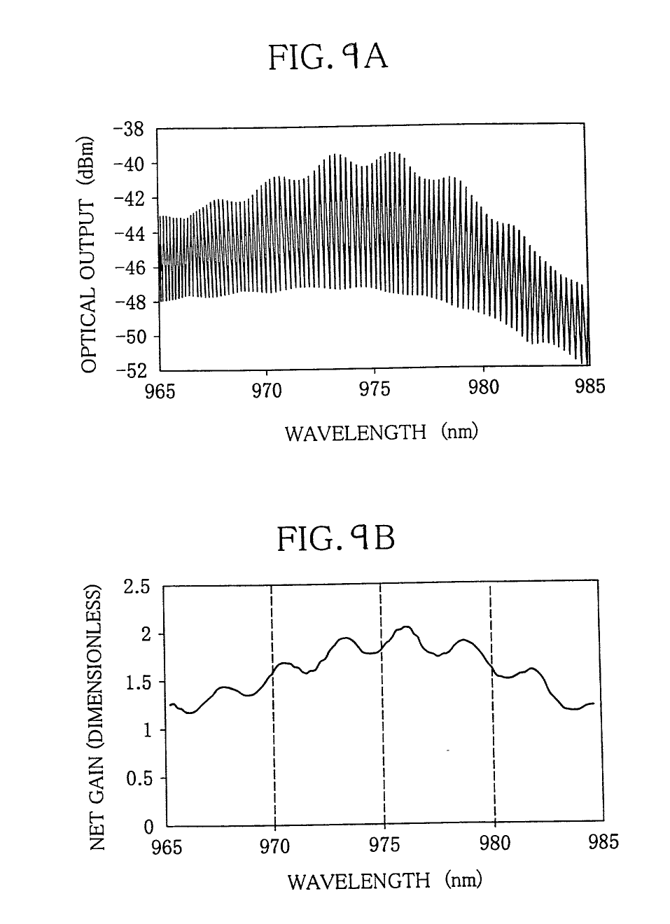

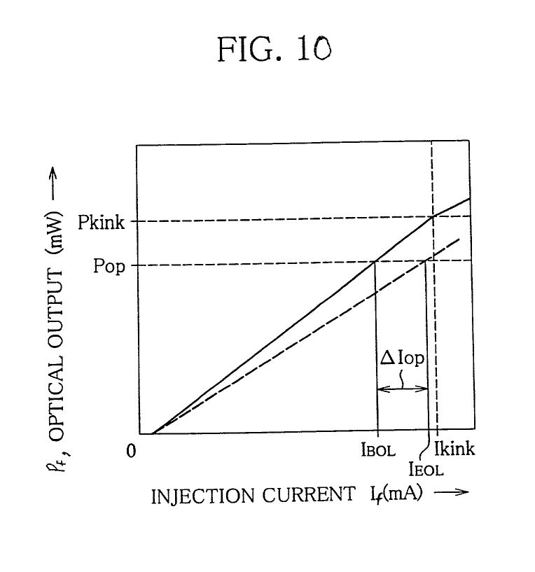

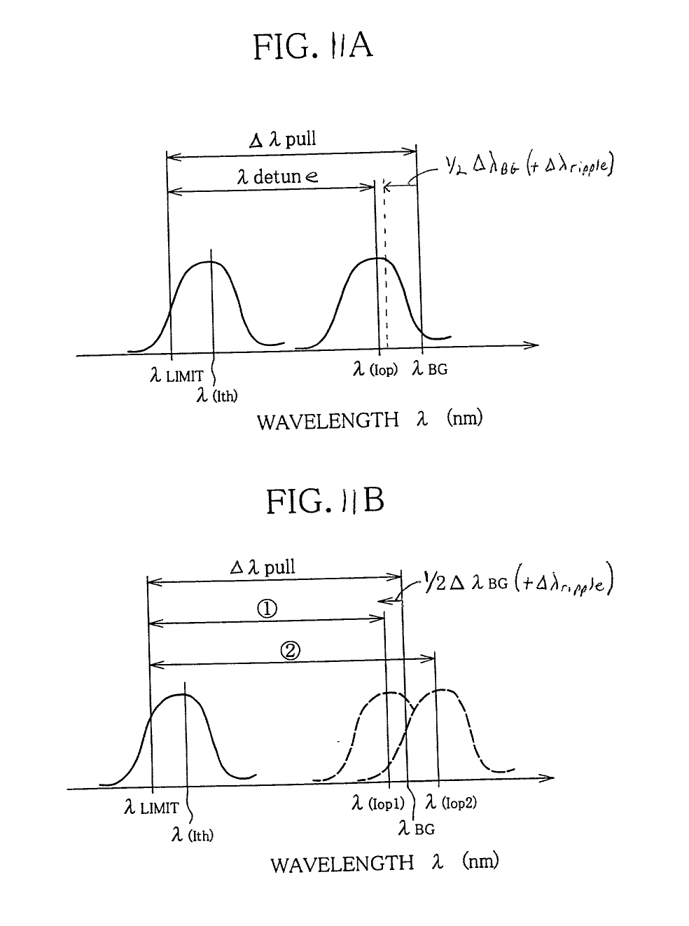

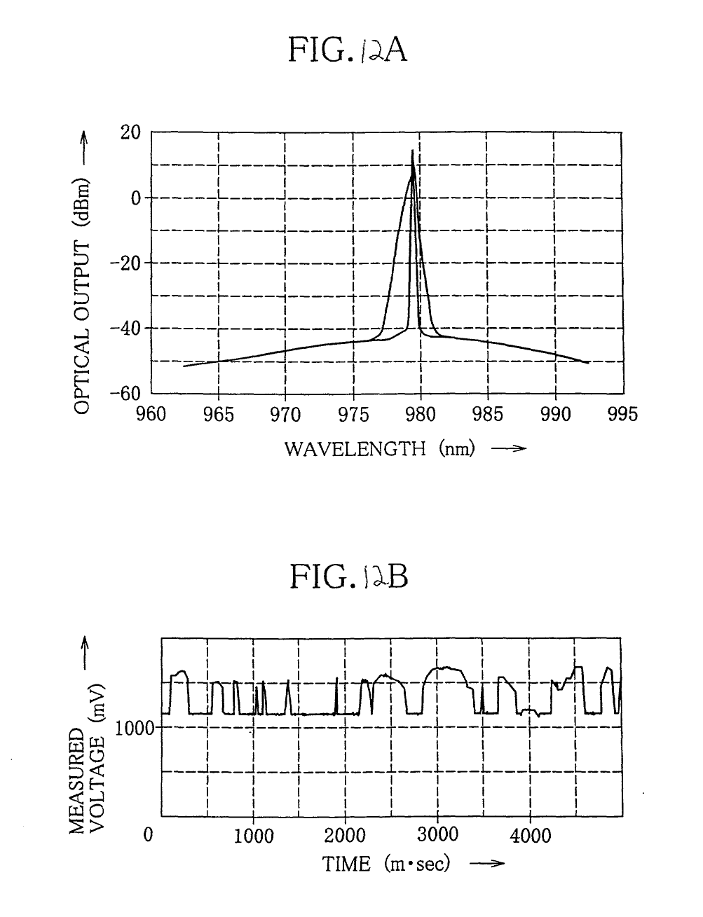

FIG. 2 is a graph of wavelength versus power output for a detuning configuration according to the present invention, when used with a multi-mode laser. As seen, modes “a” and “b” are substantially equally spaced about a center wavelength λ_{BG} of the WSFM. In this case, mode “a” will receive a greater amount of gain than mode “b”, although both are attenuated by the same amount by the WSFM, thus ensuring that mode “a” is enhanced and mode “b” is suppressed. Consequently, mode “a” will dominate mode “b,” thus ensuring that the light will be stable throughout the dynamic range of the LD. In this case, the risk of mode competition noise is mitigated as a result of favoring mode “a” over mode “b” by purposefully offsetting the semiconductor gain curve and the reflection band.

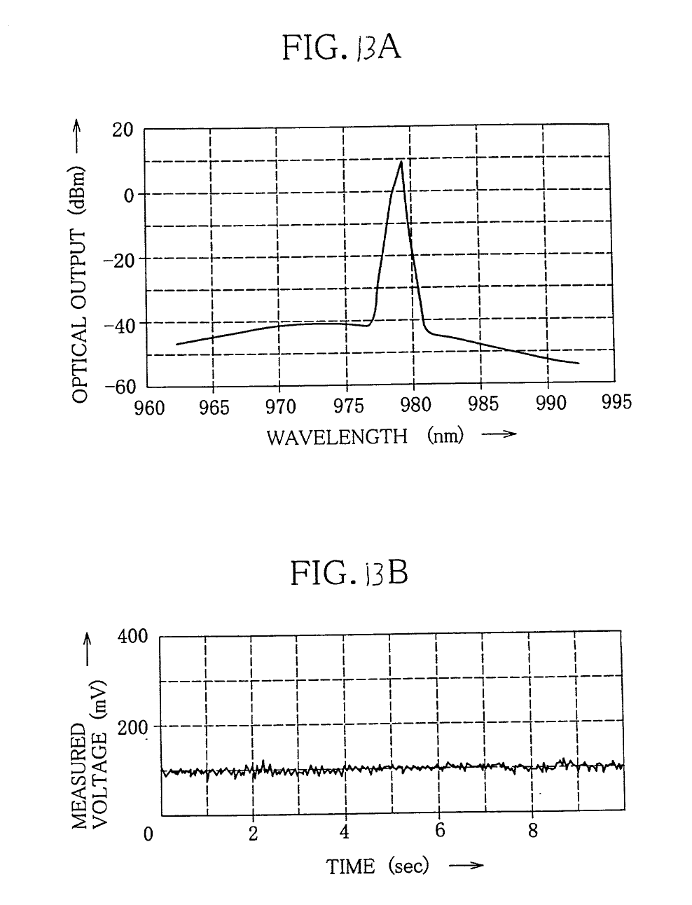

FIG. 3 is generally the same as FIG. 1, however the Fabry Perot modes b and a are subjected to a rippled gain effect often observed, for example, in the 980 nm band type of the semiconductor laser module. In this situation it is seen that even though the output level of mode b may be less than that of mode a, the greater amount of gain applied to mode b may make it of equal output power out of mode a, thus giving rise to a possibility of mode competition noise.

FIGS. 4 and 5 respectively address detuning features of the present invention for both situations where a smooth gain as well as a rippled gain are used in association with a multimode semiconductor laser. FIG. 4 shows that the center wavelength of the refection band (λ_{BG}) is offset in wavelength from a gain peak λ_{G}. In this case it is shown that a point on the reflection band that is a predetermined level below (e.g., 3 dB below a peak value of the reflection band) is established as being ½Δλ_{BG}. More generally, however, ½Δλ_{BG} is set sufficiently wide so that the reflectance band Δλ_{BG} contains multiple modes, not just one. Thus the present inventors have determined that as long as the point (λ_{BG}−½Δλ_{BG}) is on a same side of a center wavelength of a gain curve (λ_{G}) throughout the dynamic range of the LD, then the risks associated with mode competition noise and relative intensity noise (RIN) are markedly reduced. In other words, as long as the modes falling within a predetermined portion of the reflection band, extending from one edge of the predetermined bandwidth to the other edge of the predetermined bandwidth, experience an amount of gain that decreases monotonically from mode to mode, mode competition noise and RIN are suppressed.

FIG. 5 is like FIG. 4, although the gain curve includes ripples. In the gain curve, different local gain peaks (A, B, C, D) are shown to be on one side of a center wavelength of a gain peak for the semiconductor laser. As seen, the local peaks A, B, C, D decrease monotonically (relative to one another) although between local peaks the gain curve does not necessarily decrease monotonically. In this situation, the present inventors have determined that as long as the predetermined bandwidth of the reflection band (e.g., a 3 dB bandwidth, half of which is defined as ½Δλ_{BG}) may be used to define an amount of separation between the center of the reflectance band and the peak gain λ_{G}. In this case, as long as Δλ_{BG} is on a same side of the gain peak λ_{G} as (λ_{BG}−½Δλ_{BG}−Δλᵣᵢₚₚₗₑ), then mode competition noise is reduced and is also suppressed. Δλᵣᵢₚₚₗₑ is defined as being a span between two local gain peaks on the gain curve. While specific formulas are given herein, it should be noted that the general observation is that as long as the respective modes captured within a reflection band experience relatively consistent amounts of decrease in gain, then the mode competition noise is adequately suppressed. While adjacent modes need not monotonically experience a decreasing in gain, modes that coincide with relative local gain peaks, should experience a monotonically decreasing amount of gain imparted to them. In this way, both mode competition noise as well as RIN is suppressed.

FIGS. 6A-6H correspond to FIGS. 7A-7H among which FIG. 6A and 7A correspond with a multi-mode laser that did not have its optical output applied to a WSFM. Each of FIGS. 6A-6H correspond with an injection current versus monitor current characteristic for different offsets between a center reflection band and a peak gain as defined at threshold current when used with a multi-mode laser of the 14XX type.

Here, Δ in FIGS. 6A-6H means the difference of the gain peak wavelength λ_{G} and the center wavelength λ_{BG} of the refection band of the WSFM.

A same LD was used, with different gratings to create these figures, where the different gratings were designed to have center reflectance wavelengths that are progressively offset in wavelength from the peak gain of the LD. FIGS. 7A-7H, which correspond to FIGS. 6A-6H, show respective output spectrums from the lasers after being applied to the reflection band from the fiber Bragg grating (for instance).

As is seen in FIG. 7B, where the amount of offset between the center wavelength of the reflection band and the gain peak λ_{G} is ≦0, there are substantial spurs and “kinks” that exist in the characteristic function. This characteristic function is developed by increasing the injection current I_{f} throughout a dynamic range of the laser diode. While the injection current I_{f} does not change drastically from one level to the next in operation, manufacturers specify the operation of the device in a “kink free” operation range so that customers may reliably use the device at any injection current I_{f}, say between 25 mA and 1000 mA. When operated over this full dynamic range of the injection current I_{f}, the manufacturer's specification should be able to predict with a high degree of certainty (free of kinks) the monitor current Iₘ that will verify a proper operation of the semiconductor laser.

As can be seen in FIGS. 6C, 6D, 6E and 6F kinks persists in the characteristic function of the LD, thus making linear operational characteristic difficult to specify. On the other hand, above 11.5 nm, such as 12 nm or at 14.5 nm as shown in FIG. 6G, at 16.5 nm shown in FIG. 6H (or even 19.5 nm) not shown, as well as values from greater than 11.5 nm through 19.5 nm, linear operations exist. Thus, by offsetting the center wavelength of the reflection band from the gain peak λ_{G} by greater than 11.5 nm, it is possible to provide linear operation throughout the driving range of 25-300 mA.

Offsetting, or detuning, the gain peak with respect to the center wavelength of the reflection band by a predetermined amount ensures that modes on opposite sides of a center wavelength of a reflectance band are not provided with the same amount of gain. Moreover, by ensuring that a gain imparted on an output spectrum of a multimode laser decreases monotonically, albeit perhaps on a local peak basis for gain curves with a ripple, mode competition between symmetrically spaced modes is reduced. Reducing mode competition avoids the possibility of having kinks occur throughout the dynamic range of the laser module.

FIG. 8 is a schematic illustrating a Raman amplifier that uses semiconductor laser modules 101-108 having semiconductor lasers with wavelength selective feedback mechanisms (WSFMs), “detuned” in wavelength, according to the present invention. Laser modules 106-107 may be used as spares (even though they are not shown), and switched on/off by a controller, not shown. The WSFM is optically coupled to the semiconductor laser and configured to have a characteristic reflectance band centered at λ_{BG} and with a width Δλ_{BG} set to contain more than one modes of light output from the semiconductor laser. Both (1) [λ_{BG}−½Δλ_{BG}] and (2) [λ_{BG}+½Δλ_{BG}] describe wavelengths that are either both greater than λ_{G} or both less than λ_{G}. Moreover, the center wavelength of the WSFM may be offset from the peak gain by a positive amount or a negative amount. The center frequency (while frequency is used in this example, the same description may be given in terms of wavelength) of the WSFM for the first laser module 101 is 211 THz (a wavelength of 1420.8 nm) and the frequencies of the second to eighth laser modules 102-108 are from 210 THz (a wavelength of 1427.6 nm) to 204 THz (a wavelength of 1469.6 nm). Each slot for the laser modules 101-108 is spaced apart from each other by an interval of 1 THz. Note, however, that the laser modules 106 and 107 are not in operational use, but they may nonetheless be in the Raman amplifier in an inactive state, ready to be turned on if a controller determines that they are needed to dynamically reconfigure the amplification bandwidth, or needed for use as an “inbox” spare. In addition, the wavelength interval between adjacent operating laser modules is within an inclusive range from 6 nm to 35 nm. Further, the number of laser modules operating at the shorter wavelength side (with respect to the middle wavelength between the shortest and longest center wavelengths) is greater than the number of laser modules operating at the longer wavelength side. That is, the middle frequency between the first laser module 101 and eighth laser module 108 is at about 207.5 THz. Thus, laser modules 101-104 (i.e., four laser modules) are operating on the shorter wavelength side and laser modules 105 and 108 (i.e., two laser modules) are operating on the longer wavelength side.

In a pump laser for an optical fiber amplifier, a GaAs/AlGaAs-based semiconductor laser having a resonance mode form of a gain wavelength characteristic in a natural emission region shown in FIG. 9A and a net gain form shown in FIG. 9B is designed to construct a semiconductor laser module of an external-cavity type by using a wavelength selective feedback mechanism (WSFM) such as a Bragg grating. In this case, the module has the following features based on the relation between the reflection center wavelength λ_{BG} of the Bragg grating and the gain peak wavelength λ_{G} of the semiconductor laser.

FIG. 10 is a diagram that shows a relation between injection current I_{f} and optical output P_{f}. Optical output P_{f} of the semiconductor laser decreases as it ages. The solid curve in FIG. 10 is an I-L curve at initial condition before aging, so-called beginning of life(BOL). The dotted and inclined line in FIG. 10 shows the predicted I-L curve at the end of life(EOL), for example, 25 years after BOL.

The optical output Pₖᵢₙₖ and the injection current Iₖᵢₙₖ are defined as the lowest optical output and the lowest current at which the kink effect appears in FIG. 10. Pₖᵢₙₖ is often called “kink power” and Iₖᵢₙₖ is often called “kink current”. The rated operating power Pop and the operating current at BOL (I_{BOL}) may be determined as 15-20% below Pₖᵢₙₖ and Iₖᵢₙₖ respectively. The operating current at EOL (I_{EOL}) may typically be defined as 1.1-1.3 times larger than I_{BOL} in consideration of the product life-time. ΔIop indicated by the arrow in FIG. 10 is given by the difference between I_{EOL} and I_{BOL}.

The operating current Iₒₚ of a laser in the present document must be set within the range of ΔIₒₚ in order for the laser to be operated in kink-free state.

FIGS. 11A and 11B are diagrams that show the change of the gain peak wavelength λ_{G} due to the change of the injection current I_{f}. In these figures, the shortest locking wavelength limit λ_{LIMIT} is the gain peak wavelength with which the oscillation mode of the semiconductor laser module changes from the Bragg grating mode into the Fabry-Perot mode. In these figures, λ (Iₜₕ) is the gain peak wavelength at the threshold current Iₜₕ with which the laser oscillation begins, and the pulling wavelength width Δλ_{PULL} is the difference between the reflection center wavelength λ_{BG} of the Bragg grating and the shortest locking wavelength limit λ_{LIMIT}.

FIG. 11A shows gain wavelength characteristic curves illustrating optimum relations between the reflection center wavelength λ_{BG} of the Bragg grating, pulling wavelength width Δλ_{PULL}, detuning width Δλ_{detune}, shortest locking wavelength limit λ_{LIMIT} of the pulling, and gain peak wavelengths λ_{G}(Iₒₚ) and Δ_{G}(Iₜₕ) for the case where an optical output P_{f} and a monitor current (Iₘ) of the semiconductor laser are stable.

FIG. 11A indicates that the gain peak wavelength λ_{G} of the semiconductor laser is offset from the reflection center wavelength λ_{BG} of the Bragg grating, and a pulling wavelength width Δλ_{PULL} and a detuning width Δλ_{detune}, defined below so that the detuning width Δλ_{detune} is smaller than the pulling wavelength width Δλ_{PULL}. The resulting difference (Δλ_{PULL}−Δλ_{detune}) is greater than the half width at half maximum of the reflection spectrum of the Bragg grating, with the gain peak wavelength λ_{G} at threshold being greater than the shortest locking wavelength limit λ_{LIMIT}.

The optical output P_{f} and monitor current Iₘ of the semiconductor laser can be stabilized by constructing the semiconductor laser module in the above manner.

Preferably, the semiconductor laser module is designed such that a gain peak wavelength λ_{G} of the semiconductor laser is shorter than the reflection wavelength of the Bragg grating as shown in FIG. 11A.

On the other hand, FIG. 11B shows gain wavelength characteristics curves illustrating relations between the reflection center wavelength λ_{BG} of the Bragg grating, pulling wavelength width Δλ_{PULL}, detuning width Δλ_{detune}, shortest locking wavelength limit λ_{LIMIT} of the pulling, and gain peak wavelengths λ_{G}(Iₒₚ) and λ_{G}(Iₜₕ) for the case where an optical output P_{f} and a monitor current (Iₘ) of the semiconductor laser are considerably unstable.

FIG. 11B indicates the detuning width Δλ_{detune} for the case where a gain peak wavelength λ_{G}(Iₒₚ₁) is greater than a wavelength (λ_{LIMIT}+Δλ_{PULL}−½Δλ_{BG}), where Δλ_{BG} is the full width at half maximum of the reflection spectrum of the Bragg grating around the reflection center wavelength λ_{BG} of the Bragg grating, and detuning width Δλ_{detune} for the case where a gain peak wavelength λ_{G}(Iₒₚ₂) is greater than the reflection center wavelength λ_{BG} (λ_{LIMIT}+Δλ_{PULL}).

With the detuning width Δλ_{detune} in these states, the oscillation modes compete within the full width at half maximum Δλ_{BG} around the reflection center wavelength λ_{BG} of the Bragg grating, therefore the monitor current Iₘ varies by several percent or more, and exhibits a spike-shaped fluctuation.

Moreover in these states, when a lot of gain ripple peaks exist around the reflection center wavelength λ_{BG} of the Bragg grating and when the oscillation modes of the semiconductor laser exist near λ_{BG}, the oscillation modes of the semiconductor laser compete between the gain ripple peak wavelengths and the reflection center wavelength λ_{BG} of the Bragg grating, which causes the monitor current Iₘ to vary by several percent or more in a spike-shaped manner.

For the case of reflection center wavelength λ_{BG} being close to the gain peak wavelength λ_{G} as shown in FIG. 11B, an oscillation spectrum exhibits a random mode hopping between a state of a plurality of modes competing each other and a state of fewer modes in oscillation, as shown in FIG. 12A, causing the monitor current to fluctuate, as shown in FIG. 12B. In FIG. 12B, the fluctuation in the monitor current is shown in terms of the change in the voltage at monitor photo diode versus time.

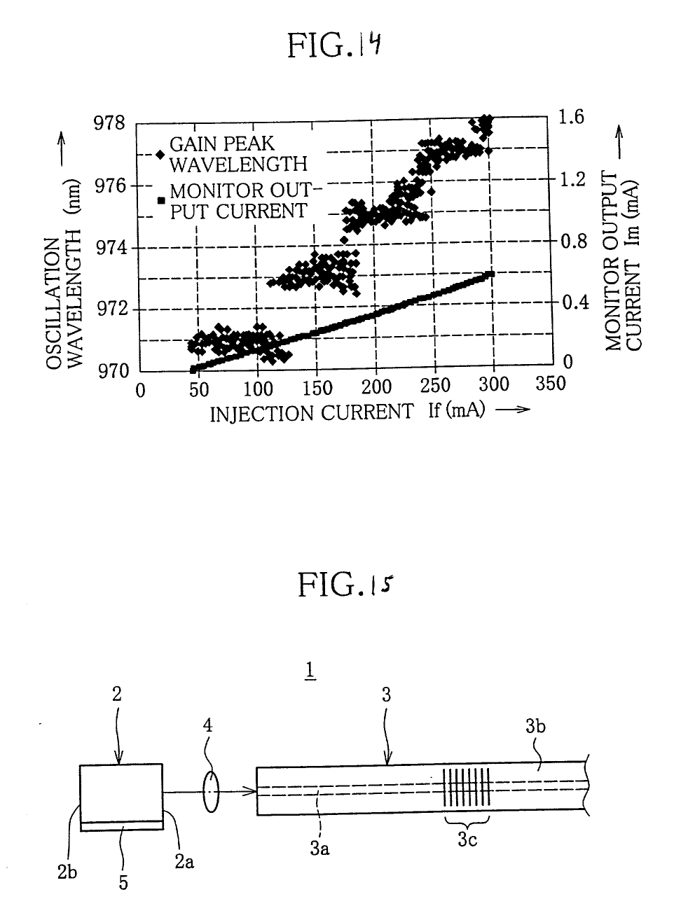

For the case of reflection center wavelength λ_{BG} being apart from the gain peak wavelength λ_{G} as shown in FIG. 11A, on the other hand, an oscillation spectrum exhibits no mode hopping and the fluctuation in the monitor current Iₘ disappears as shown in FIGS. 13A and 13B.

It is to be noted here that the ordinate and abscissa of FIGS. 12B and 13B have different graduations.

Further, since the semiconductor laser module of the present invention is configured so that the gain peak wavelength λ_{G}(Iₒₚ) for the operating current Iₒₚ is shorter than the reflection center wavelength Δ_{BG}, sub-peaks on the shorter wavelength side of a gain ripple are higher than sub-peaks on the longer wavelength side so that mode competition associated with the gain ripple within the full width at half maximum Δλ_{BG} of the Bragg grating is prevented, which results in suppression of mode competition between the Bragg grating mode and the gain- ripple- associated Fabry-Perot modes, and stable optical output P_{f} and monitor current Iₘ.

Preferably, the reflection center wavelength λ_{BG} of the Bragg grating is set on the longer wavelength side of gain peak wavelength λ_{G}(Iₒₚ) by at least one gain ripple (e.g. by 3 nm longer in FIG. 9B).

The semiconductor laser module thus designed can prevent the mode competition between the Bragg grating mode and the ripple-sub- peak-associated Fabry-Perot modes which otherwise possibly oscillates at around the wavelength that is one gain ripple longer than the dominant gain peak and consequent instability in optical output P_{f} and in the monitor current Iₘ.

Preferably, furthermore, the semiconductor laser module is configured so that the difference between the reflection center wavelength λ_{BG} of the Bragg grating and the gain peak wavelength λ_{G}(Iₜₕ) at threshold is set at a large value given by

λ_{BG}−λ_{G}(Iₜₕ)−½Δλ_{BG}(−Δλᵣᵢₚₚₗₑ)>Λs×(Iₒₚ−Iₜₕ)

where Λs (nm/mA) is the shift of gain peak wavelength λ_{G} per unit current.

The inequality above mentioned can be used to select semiconductor lasers so that the gain peak wavelength λ_{G} remains shorter than reflection center wavelength λ_{BG} over the entire dynamic range of the operating current Iₒₚ by specifying λ_{BG}, Λs, Iₜₕ, and Iₒₚ.

For example, in case a GaAs-based semiconductor laser having ripples in gain-wavelength characteristics is used, the difference between the reflection center wavelength λ_{BG} of the Bragg grating and the gain peak wavelength at threshold λ_{G}(Iₜₕ) (the left-hand side of above inequality) is set at 7 nm or more.

As has been discussed with regard to FIGS. 6A-6H and FIGS. 7A-7H, the difference should preferably be 11.5 nm or more for the case of 14XX nm lasers of InGaAs or InGaAsP based materials.

Namely, for the case of a 980 nm laser designed to operate at optical output of 100 mW or more, the shift ratio Λs typically ranges from 0.02 to 0.03 (nm/mA) and the dynamic range of the injection current I_{f} to the laser is about 200 mA. Therefore, the shift of the gain peak wavelength λ_{G} due to the change in injection current is typically 4-6 nm as shown in FIG. 14 by the variation in gain peak wavelength λ_{G} between at threshold (40 mA) and at 240 mA.

Therefore, taking into account the offset associated with the gain ripple, the difference (λ_{BG}−λ_{G}(Iₜₕ)) between the reflection center wavelength λ_{BG} and the gain peak wavelength λ_{G} is 7 nm or more.

Preferably, the semiconductor laser is provided with a temperature control mechanism such as a Peltier device in order to keep the gain peak wavelength λ_{G} constant thereby to maintain the preset relation between the gain peak wavelength λ_{G} and reflection center wavelength λ_{BG} that gives a stable oscillation.

As shown in FIG. 15, a semiconductor laser module 1 is provided with a semiconductor laser device 2, an optical fiber 3 opposed to the semiconductor laser device 2 at a given space therefrom, and an optical coupling mechanism 4 located between the laser device 2 and the optical fiber 3.

The optical coupling mechanism that is used to couple the optical transmission medium and the semiconductor laser may be either a wedge-lensed fiber or a two-lens system.

The semiconductor laser device 2 has an emission surface (front end face) 2a for emitting excitation light and a reflective surface (rear end face) 2b opposed to the emission surface 2a. A low-reflection film of 1% reflectance (although less that 1% may be used as well, such as reflectance in a range of 0.2% to 0.75% or 0.1% up to 1%) is formed on the emission surface 2a of the semiconductor laser device 2, and a high-reflection film of 92% reflectance on the reflective surface 2b.

The semiconductor laser device 2 is a GaAs/AlGaAs-based semiconductor laser that has ripples in its gain-wavelength characteristic. In a single state, it has a cavity length of 800 μm, waveguide refractive index of about 3.4, and absorption coefficient of 8 cm⁻¹. Its active layer is a double quantum well (DQW) structure having a width of 4.3 μm, thickness of 14 nm, and active layer confinement coefficient of 2.5×10⁻². Alternatively, a 14XX laser may be used as discussed above with SL-GRIN-SCH-MQW active layers.

Further, the semiconductor laser device 2 is provided with a Peltier device 5 such that a desired gain peak wavelength λ_{G}(I_{f}) can be outputted for a given injection current I_{f}. The Peltier device 5 is adjusted to room temperature or the working temperature of the semiconductor laser device 2. In the case of a 980 nm band semiconductor laser that is used in an ordinary erbium doped fiber amplifier (EDFA), for example, the temperature is adjusted to 25° C. The same may be done for 14XX semiconductor lasers used as pump lasers for Raman amplifiers.

The semiconductor laser device 2 and the grating portion 3c are spaced at a distance of about 1 m.

Preferably, the reflectance of the optical transmission medium for the reflection center wavelength λ_{BG} of the Bragg grating is 3% or more.

The optical fiber 3 is an optical transmission medium that includes a core 3a and a clad 3b, the core 3a having a grating portion 3c formed of a Bragg grating. Alternatively, instead of a FBG, another wavelength selective mechanism may be used with the 980 nm or 14XXnm semiconductor laser, such as an optical filter, or DBR, for example.

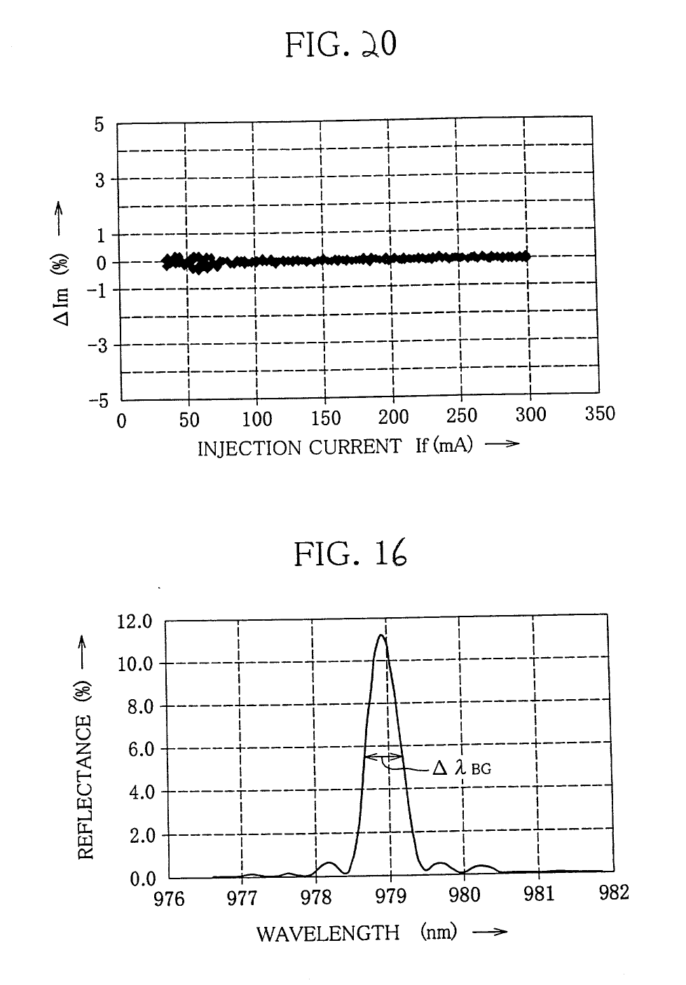

In the FBG embodiment, the grating portion 3c is an optical feedback medium that returns some of the optical output to the semiconductor laser device 2 and passes though other optical output in the optical fiber 3. The grating portion 3c is formed in the core 3a by changing the refractive index along the optical axis. It is formed so that its reflectance and full width at half maximum Δλ_{BG} for a reflection center wavelength λ_{BG} (=978.95 nm) are 11.2% and 0.51 nm, respectively, as shown in the spectrum characteristic curve of FIG. 16. Thus, although the grating portion 3c is a uniform grating, as seen from FIG. 16, it is to be understood that any other type, such as a chirped grating, short-period grating or long-period grating, may be used as the Bragg grating formed in the optical fiber 3.

The lens 4 serves to optically couple the semiconductor laser device 2 and the optical fiber 3. The lens 4 may be a wedge-lens formed at the fiber end, for example. The lens 4 is located at a distance of about 10 μm from the semiconductor laser device 2, and the efficiency of coupling between the semiconductor laser device 2 and the optical fiber 3 is 60% or more. The coupling efficiency with the lens 4 formed as the wedge-lens was measured and found to be about 75%.

The typical values of the gain peak wavelength λ_{G}, the reflection center wavelength λ_{BG} and the bandwidth Δλ_{BG} of the reflection band of the grating portion 3c according to the present invention and the relation therebetween will be discussed hereinafter.

The characteristic values of the semiconductor laser device 2 are, for example, as follows.

Iₖᵢₙₖ>300 mA

I_{BOL}=200 mA

I_{EOL}=240 mA

Iₜₕ=42.4 mA

λ_{G}(Iₜₕ)=970.8 nm (average)

λ_{G}(Iₒₚ)=975 nm (average)

Δλᵣᵢₚₚₗₑ=2.5 nm.

The Iₖᵢₙₖ is the injection current where the kink occurs. The injection current I_{BOL} is the injection current where the optical output is thirty and several percent below the Pₖᵢₙₖ. The injection current I_{EOL} is defined as 1.2 times as large as I_{BOL} in this case.

FIG. 14 shows the measured relations between injection current I_{f} (mA) and the oscillation wavelength (nm) and between injection current I_{f} (mA) and the monitor current Iₘ (mA) of the solitary semiconductor laser device 2.

In this diagram, the oscillation wavelength was read ten times using a spectrum analyzer at each of injection currents I_{f} for the semiconductor laser device 2 that was increased by steps of 2 mA. Thus, in FIG. 14, ten square marks are dotted at each injection current value.

As seen from FIG. 14, threshold current Iₜₕ of solitary semiconductor laser device 2 is found to be 42.4 mA. The average of gain peak wavelength λ_{G}(Iₜₕ) based on 10 times of measurement is calculated to be about 970.8 nm and the average of the gain peak wavelength λ_{G}(Iₒₚ) based on 10 times of measurement is calculated to be about 975 nm.

FIG. 17 shows the output spectrum characteristic of the solitary semiconductor laser device 2 and the gain ripple spacing Δλᵣᵢₚₚₗₑ is found to be 2.5 nm for this diagram .

The characteristic values of the grating portion 3c are as follows, as shown in FIG. 16.

λ_{BG}=978.95 nm

Δλ_{G}=0.51 nm.

With these parameters of the semiconductor laser device 2 and the grating portion 3c, it is understood that the gain peak wavelength λ_{G}(Iₒₚ) (=975 nm ) is set shorter than (λ_{BG}−½Δλ_{BG}−Δλᵣᵢₚₚₗₑ)(=976.2 nm). Accordingly, the semiconductor laser module thus designed can prevent the mode competition between 2 Fabry-Perot modes and between the Bragg grating mode and the ripple-sub- peak-associated Fabry-Perot modes, and ensure the stable oscillation in Bragg grating mode.

The semiconductor laser module 1 complies with the condition of this invention using the pulling wavelength width Δλ_{PULL} and the de-tuning width Δλ_{detune}. For example, the pulling wavelength width Δλ_{PULL} is about 10.74 nm according to theoretical calculation, not expressly discussed herein, with the physical property parameters of the semiconductor laser device 2 (refer to Mugino et.al.: “1480 nm Pump Laser with Fiber Bragg Grating”, Technical report of IEICE, LQE 98-48(1998-08), P37), the contents of which being incorporated herein by reference.

With the theoretical value of Δλ_{PULL}, the shortest locking wavelength limit λ_{LIMIT} is about 968.21 nm, that is given by (λ_{BG}−Δλ_{PULL}). Thus, the de-tuning width Δλ_{detune} is 975-968.21 nm=5.79 nm.

Therefore, it is understood that the difference(Δλ_{PULL}−Δλ_{detune}) is greater than (½Δλ_{BG}+Δλᵣᵢₚₚₗₑ) (=2.75 nm).

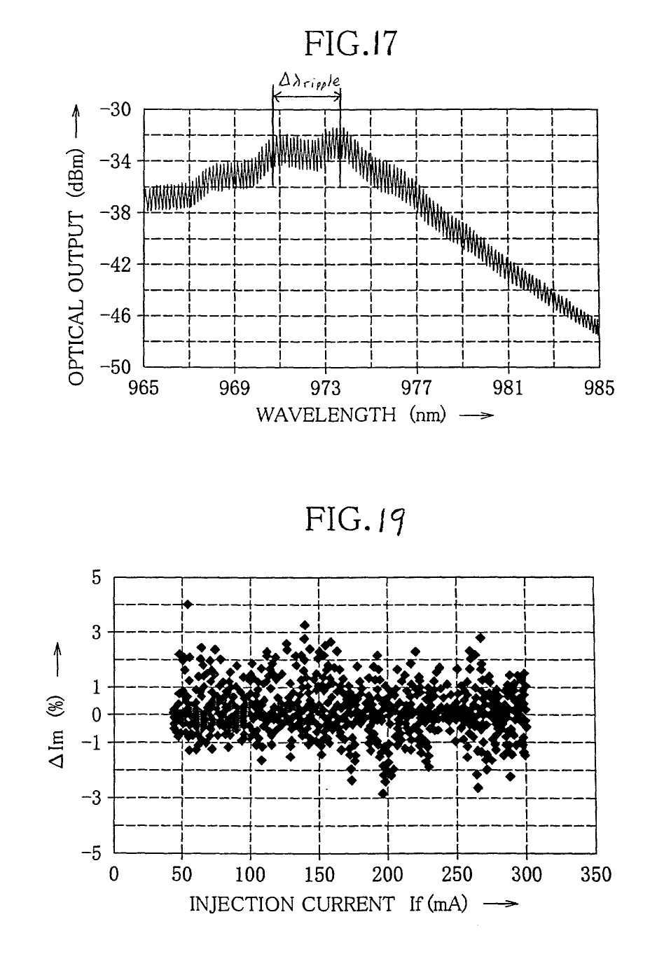

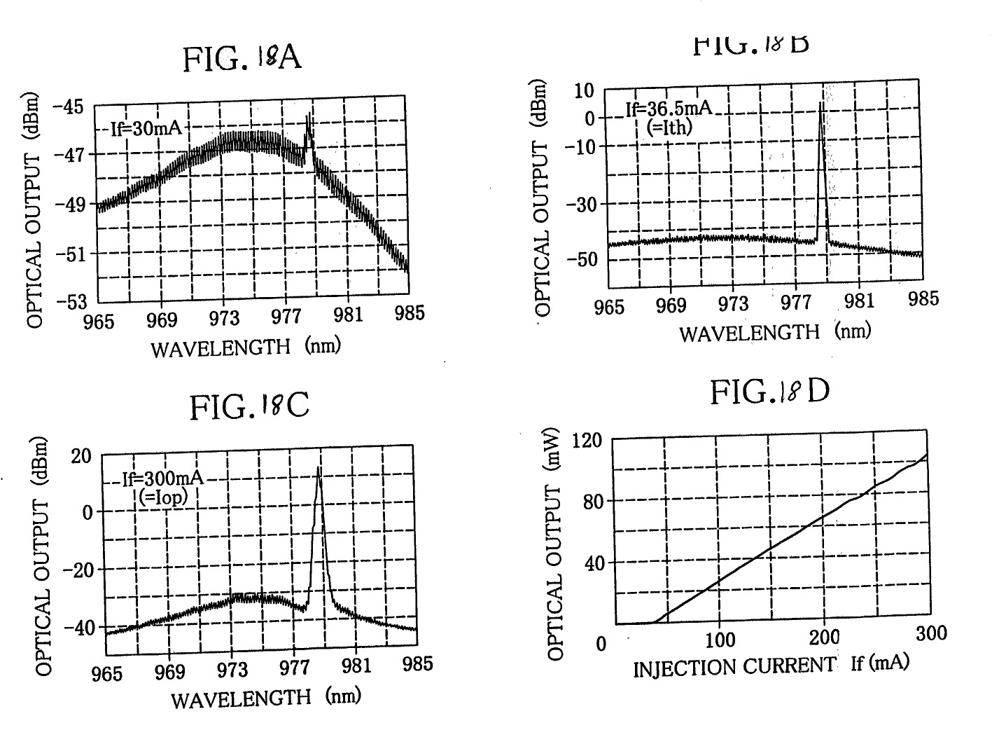

The effect of this invention in above mentioned case will be described hereinafter with FIGS. 18A-18D, 19, and 20.

FIGS. 18A to 18D individually show spectrum characteristics of the semiconductor laser module 1 by way of the spectrum analyzer and an optical output characteristic by way of a power meter.

FIG. 18A was taken at 30 mA (spontaneous emission region not higher than the threshold current Iₜₕ of the semiconductor laser device 2), FIG. 18B at 36.5 mA that is equal to the threshold current Ith, and FIG. 18C at 300 mA.

As seen from FIGS. 18A to 18C, the oscillation wavelengths of the semiconductor laser device 2 for the individual injection currents are located close to the reflection center wavelength λ_{BG} (978.95 nm) of the grating portion 3c. As is evident from FIG. 18B, moreover, the semiconductor laser device 2 oscillates in a Bragg grating mode and not in Fabry-Perot mode at threshold current Iₜₕ, so that the gain peak wavelength λ(Iₜₕ) is greater than the shortest locking wavelength limit value λ_{LIMIT}. The optical output was measured to be stable up to 300 mA.

As seen from the result shown in FIG. 18D, on the other hand, there is a linear relation between the injection current (mA) and optical output (mW) of the semiconductor laser device 2 in the semiconductor laser module 1 as long as the injection current is between the threshold current Iₜₕ (=36.5 mA) and the maximum operating current I_{EOL} (=200 mA).

FIG. 19 shows the injection current dependence of a variation in a monitor current ΔIₘ(%) of the solitary semiconductor laser device 2. On the other hand, FIG. 20 shows the injection current dependence of the variation in the monitor current ΔIₘ(%) of the semiconductor laser device 2 that is assembled in the semiconductor laser module 1 according to the present invention.

I_{f} the pulling wavelength width Δλ_{PULL} and the de-tuning width Δλ_{detune} are adjusted to the optimum relation as shown in FIG. 11A, the variation in the monitor current ΔIₘ (%) over the entire region of the injection current I_{f} can be restricted to within ±0.5%, as shown in FIG. 20.

According to the embodiment described above, the optical fiber 3 having the grating portion 3c is used as the optical transmission medium. It is to be understood, however, that a planar optical waveguide may be used instead as far as it includes the Bragg grating.

According to a first feature of the present invention, stable optical output is obtained over a confined dynamic range of an injection current into the laser diode by detuning, or offsetting, a peak wavelength of a WSFM relative to a peak gain wavelength of the laser diode.

According to a second feature of the present invention, there may be provided a semiconductor laser module that is stable over the change in injection current and temperature, and is suited for use as a light source for EDFA excitation or a high-output, low-noise light source, such as for use as a pump laser for a Raman amplifier.

According to a third feature of the present invention, the semiconductor laser module is designed so that the optical output P_{f} and the monitor current Iₘ of the semiconductor laser can be stabilized more securely.

According to a fourth feature of the present invention, the semiconductor laser module can use a conventional GaAs/AlGaAs-based semiconductor laser that has ripples in its gain-wavelength characteristic, as well as an InP or InGaAsP laser for use as a pump laser in a Optical Fiber Amplifier.

Obviously, numerous modifications and variations of the present invention are possible in light of the above teachings. It is therefore to be understood that within the scope of the appended claims, the invention may be practiced otherwise than as specifically described herein.

1. A semiconductor laser module comprising:
a semiconductor laser having a light emission surface and a reflection surface, said semiconductor laser being configured to simultaneously produce multiple modes of light over a predetermined emissions bandwidth, said multiple modes of light being centered at a peak gain, λ_{G};and
a wavelength selective feedback mechanism optically coupled to said semiconductor laser and configured to have a characteristic reflectance band centered at λ_{BG} and a width Δλ_{BG} set to contain more than one of said multiple modes of light, wherein
both of [λ_{BG}−½Δλ_{BG}] and [λ_{BG}+½Δλ_{BG}] having wavelengths that are at least one of
greater than λ_{G}, and
less than λ_{G}.

2. The laser module of claim 1, wherein said semiconductor laser having an active is layer including at least one of a InGaAs and InGaAsP material.

3. The laser module of claim 2, wherein λ_{G} being in an inclusive range of 1350 nm through 1550 nm.

4. The laser module of claim 1, wherein λ_{G} being in an inclusive range of 970 nm through 990 nm.

5. The laser module of claim 1, wherein said wavelength selective feedback mechanism being a fiber Bragg grating, said fiber Bragg grating being optically coupled to said semiconductor laser and configured to receive the multiple modes of light through said light emission surface.

6. The laser module of claim 1, wherein said wavelength selective feedback mechanism being an optical filter optically coupled to said semiconductor laser and configured to receive the multiple modes of light through said light emission surface.

7. The laser module of claim 6, wherein said optical filter being a multilayer thin film optical filter.

8. The laser module of claim 2, wherein:
said semiconductor laser being at least one of a distributed feedback laser and a distributed Bragg reflector laser; and
said wavelength selective feedback mechanism being a diffraction grating contained within the semiconductor laser.

9. The semiconductor laser module of claim 1, wherein said width of said characteristic reflectance band being a 3 dB bandwidth.

10. The semiconductor laser module of claim 1, wherein a gain curve of said semiconductor laser being free of ripples in said width Δλ_{BG}.

11. The laser module of claim 10, wherein said gain curve of said semiconductor laser decreases monotonically through said width Δλ_{BG}.

12. The laser module of claim 10, wherein said gain curve of said semiconductor laser increases monotonically through said width Δλ_{BG}.

13. The semiconductor laser module of claim 1, wherein a gain curve for said semiconductor laser having ripples with local peaks in said width Δλ_{BG}.

14. The semiconductor laser module of claim 13, wherein said local peaks of said gain curve decrease monotonically through said width Δλ_{BG}.

15. The semiconductor laser module of claim 13, wherein said local peaks of said gain curve increase monotonically through said width Δλ_{BG}.

16. The semiconductor laser module of claim 1, wherein λ_{G} is <(λ_{BG}−½Δλ_{BG}).

17. The laser module of claim 1, wherein ABS (λ_{G}−λ_{BG})>11.5 nm.

18. The semiconductor laser of claim 17, wherein ABS (λ_{G}−λ_{BG})>14 nm.

19. The laser module of claim 18, wherein ABS (λ_{G}−λ_{BG})>16 nm.

20. The laser module of claim 1, wherein said light emission surface having an anti-reflection coating with a reflection coefficient of 1% or less.

21. The laser module of claim 20, wherein said reflection coefficient being in an inclusive range of 0.1% through 1%.

22. The semiconductor laser module of claim 21, wherein said reflection coefficient being in an inclusive range of 0.2% through 0.6%.

23. The semiconductor laser module of claim 1, wherein ABS (λ_{G}−λ_{BG}) being a sufficient amount such that a monitor current remains linear over an inclusive range of injection currents from 50 mA through 300 mA.

24. A Raman amplifier configured to amplify WDM signals propagating through an optical fiber, comprising:
a plurality of semiconductor laser modules each of which being configured to output light at different central wavelengths; and
an optical coupler configured to couple the light from the plurality of semiconductor lasers into said optical fiber, each of said plurality of semiconductor laser modules including
a semiconductor laser having a light emission surface and a reflection surface, said semiconductor laser being configured to simultaneously produce multiple modes of light over a predetermined emissions bandwidth, said multiple modes of light being centered at a peak gain, λ_{G}, and
a wavelength selective feedback mechanism optically coupled to said semiconductor laser and configured to have a characteristic reflectance band centered at λ_{BG} and with a width Δλ_{BG} set to contain more than one of said multiple modes of light, wherein
both of [λ_{BG}−½Δλ_{BG}] and [λ_{BG}+½Δλ_{BG}] having wavelengths that are at least one of
greater than λ_{G}, and
less than λ_{G}.

25. The Raman amplifier of claim 24, wherein said semiconductor laser having an active layer including at least one of an InGaAs material and an InGaAsP material.

26. The Raman amplifier of claim 25, wherein λ_{G} being in an inclusive range of 1350 nm through 1550 nm.

27. The Raman amplifier of claim 24, wherein λ_{G} being in an inclusive range of 970 nm through 990 nm.

28. The Raman amplifier of claim 24, wherein said wavelength selective feedback mechanism being a fiber Bragg grating, said fiber Bragg grating being optically coupled to said semiconductor laser and configured to receive the multiple modes of light through said light emission surface.

29. The Raman amplifier of claim 24, wherein said wavelength selective feedback mechanism being an optical filter optically coupled to said semiconductor laser and configured to receive the multiple modes of light through said light emission surface.

30. The Raman amplifier of claim 29, wherein said optical filter being a multilayer thin film optical filter.

31. The Raman amplifier of claim 25, wherein:
said semiconductor laser being at least one of a distributed feedback laser and a distributed Bragg reflector laser; and
said wavelength selective feedback mechanism being a diffraction grating contained within the semiconductor laser.

32. The Raman amplifier of claim 24, wherein said width of said characteristic reflectance band being a 3 dB bandwidth.

33. The Raman amplifier of claim 24, wherein a gain curve for said semiconductor laser being free of ripples.

34. The Raman amplifier of claim 33, wherein said gain curve of said semiconductor laser decreases monotonically through said width of said characteristic reflectance bands.

35. The Raman amplifier of claim 33, wherein said gain curve of said semiconductor laser increases monotonically through said width of said characteristic reflectance band.

36. The Raman amplifier of claim 24, wherein a gain curve for said semiconductor laser having ripples with local peaks.

37. The Raman amplifier of claim 36, wherein said local peaks of said gain curve decrease monotonically through said width of said characteristic reflectance band.

38. The Raman amplifier of claim 36, wherein said local peaks of said gain curve increase monotonically through said width of said characteristic reflectance band.

39. The Raman amplifier of claim 24, wherein λ_{G} is <(λ_{BG}−½Δλ_{BG}).

40. The Raman amplifier of claim 24, wherein ABS (λ_{G}−λ_{BG})>11.5 nm.

41. The Raman amplifier of claim 40, wherein ABS (λ_{G}−λ_{BG})>14 nm.

42. The Raman amplifier of claim 41, wherein ABS (λ_{G}−λ_{BG})>16 nm.

43. The Raman amplifier of claim 24, wherein said light emission surface having an anti-reflection coating with a reflection coefficient of 1% or less.

44. The Raman amplifier of claim 43, wherein said reflection coefficient being in an inclusive range of 0.1% through 1%.

45. The Raman amplifier of claim 44, wherein said reflection coefficient being in an inclusive range of 0.2% through 0.6%.

46. The Raman amplifier of claim 24, wherein ABS (λ_{G}−Δλ_{BG}) being a sufficient amount such that a monitor current remains linear over an inclusive range of injection currents from 50 mA through 300 mA.

47. A semiconductor laser module comprising:
means for simultaneously producing from a semiconductor multiple modes of light over a predetermined emissions bandwidth, said multiple modes of light being centered at a peak gain, λ_{G}; and
means for suppressing mode competition between said multiple modes of light, including
means for selecting a subset of said multiple modes of light and suppressing other modes of said multiple modes of light, wherein respective differences in wavelength between said peak gain and each mode of said subset all having a same sign.

48. The laser module of claim 47, wherein said means for selecting includes means for selecting said subset of modes having wavelengths all larger than a wavelength of said peak gain.

49. The laser module of claim 47, wherein said means for selecting includes means for selecting said subset of modes having wavelengths all less than a wavelength of said peak gain.

50. The laser module of claim 47, wherein said means for suppressing includes means for suppressing RIN.

51. The laser module of claim 47, wherein a gain curve of said means for simultaneously producing contains no ripples.

52. The laser module of claim 47, wherein a gain curve of said means for simultaneously producing contains ripples.

53. A method for suppressing mode competition between modes of light produced from a semiconductor laser, comprising steps of:
identifying a wavelength of a peak gain for said semiconductor laser;
identifying a center wavelength and a predetermined bandwidth of a wavelength selective feedback mechanism;
offsetting said wavelength of said peak gain and said center wavelength of said wavelength selective feedback mechanism such that all of said predetermined bandwidth being at least one of
longer in wavelength than said peak gain, and
shorter in wavelength than said peak gain.

54. The method of claim 53, wherein a gain curve of said semiconductor laser includes ripples.

55. The method of claim 53, wherein a gain curve of said semiconductor laser does not include ripples.

56. The method of claim 53, wherein said center wavelength of said wavelength selective feedback mechanism is in an inclusive range of 1350 nm to 1550 nm.

57. The method of claim 53, wherein said predetermined bandwidth being a 3 dB bandwidth.
